(19) United States
(12) Patent Application Publication
(10) Pub. No.: US 2026/0229150 A1
(43) Pub. Date: Aug. 6, 2026

(54) TUBE TAG ASSEMBLY WITH A COLLAR

(71) Applicant: Etched, LLC, Kansas City, MO (US)

(72) Inventors: Mark Ronald Stang, Kansas City, MO (US); Adam Charles Barksdale, Kansas City, MO (US)

(73) Assignee: Etched, LLC, Kansas City, MO (US)

(21) Appl. No.: 19/044,366

(22) Filed: Feb. 3, 2025

(51) Int. Cl. G09F 3/00; G09F 3/02; G09F 3/06

(52) U.S. Cl. CPC G09F 3/0295; G09F 3/0288; G09F 3/06; G09F 2003/0222

(57) ABSTRACT

Systems, methods, and devices disclosed herein include a tube tag assembly for labelling an industrial cable (e.g., a wire rope sling). The tube tag assembly includes a collar with an aperture operable to receive a cable therethrough. The collar also includes a first mating extension protruding from a first side and a second mating extension protruding from a second side. Furthermore, the tube tag assembly includes a skirt having a first end and a second end. The first end of the skirt has at least one collar receiver for securing the skirt to the collar and forming the tube tag assembly. The at least one collar receiver includes a first indentation operable to receive the first mating extension and a second indentation operable to receive the second mating extension. Additionally, the tube tag assembly includes a label surface formed onto at least one of the collar or the skirt.

### BACKGROUND

Industrial load-bearing cables are typically formed of multiple strands of wire woven together. These types of industrial cable are often used for docking large ships or in lifting or rigging apparatuses, such as cranes, elevators, mining apparatuses, logging, excavation machines, and the like. Such cables or wire rope slings are often required to be tagged or labeled to provide lifting capability information of the wire rope, along with other information. However, using the cables in these industrial environments often causes significant wear or damage to the label. Furthermore, with the wide variety of cable shapes, sizes, and lifting limits, manufacturing labels with the versatility to match and effectively attach to every type of cable can be difficult.

It is with these observations in mind that the presently disclosed technology was conceived.

### SUMMARY

Systems, methods, and devices disclosed herein can address the aforementioned issues. For instance, a tube tag assembly can include a collar with an aperture operable to receive a cable therethrough. The tube tag assembly can also include a skirt having a first end and a second end. The first end of the skirt can have at least one collar receiver for securing the skirt to the collar and forming the tube tag assembly. Additionally, the tube tag assembly can include a label surface formed onto at least one of the collar or the skirt.

In some examples, the collar can include one or more mating extensions. Also, the collar receiver can include one or more indentations shaped to receive the one or more mating extensions. The one or more mating extensions can include a first mating extension protruding from a first side of the collar and a second mating extension protruding from a second side of the collar opposite the first side. Furthermore, the collar receiver can include a first indentation at a first side of the skirt operable to receive the first mating extension, and/or a second indentation at a second side of the skirt operable to receive the second mating extension. The skirt can also include a first cable attachment tab extending from the first end and a second cable attachment tab extending from the first end. The first cable attachment tab can extend from a third side of the skirt between the first side and the second side, and the second cable attachment tab can extend from a fourth side of the skirt between the first side and the second side. Additionally, the first side, the second side, the third side, and the fourth side can form a square profile or a rectangle profile of the skirt.

In some scenarios, the first indentation, the first mating extension, the second indentation, and/or the second mating extension are keyed features indicating a particular dimension of the tube tag assembly. The particular dimension can include a diameter of the aperture operable to receive the cable therethrough. Additionally or alternatively, the particular dimension can be indicated by text on a top surface of the collar or on a sidewall of the skirt. Furthermore, the skirt can be formed of a bent metal sheet, and, upon positioning the collar at the collar receiver of the skirt, the collar can be welded to the skirt.

In some instances, a tube tag assembly can include a collar with an aperture operable to receive a cable therethrough. The collar can include one or more mating extensions. Additionally, the tube tag assembly can include a skirt having a first end and a second end. The first end of the skirt can have at least one collar receiver to receive the one or more mating extensions of the collar; Furthermore, the tube tag assembly can include a label surface formed onto at least one of the collar or the skirt.

In some examples, the aperture can have a diameter selected from a group including at least a first value, a second value, and a third value, for instance, as part of a manufacturing process (e.g., via an input to a machine). Also, the one or more mating extensions can have a dimension indicating which of the first value, the second value, or the third value is selected for the diameter of the aperture. Moreover, the collar can have a first profile shape formed by an outer perimeter, and the skirt can have a second profile shape formed by a plurality of sidewalls. The second profile shape can match the first profile shape, and/or the first profile shape and the second profile shape can be a square, a rectangle, a triangle, or a hexagon. Furthermore, the aperture can have a circular shape corresponding to a cable having a circular cross-section. The aperture can also have a hexagonal shape corresponding to a cable having a hexagonal cross-section.

In some scenarios, a method of manufacturing a tube tag assembly can include cutting a first piece of metal into a collar having an aperture operable to receive a cable therethrough; bending a second piece of metal into a skirt having a first end and a second end, the first end of the skirt having at least one collar receiver; and/or forming a tube tag assembly by securing the skirt to the collar by positioning the collar in the collar receiver. Additionally, the cutting of the first piece of metal into the collar can include forming a first mating extension into a first side of the collar and forming a second mating extension into a second side of the collar. Furthermore, the securing of the skirt to the collar can include positioning the first mating extension into a first indentation on the skirt having a particular shape for receiving the first mating extension, and/or positioning the second mating extension into a second indentation on the skirt having a particular shape for receiving the second mating extension.

### BRIEF DESCRIPTION OF THE FIGURES

FIG. 1A illustrates an example system including a tube tag assembly for attaching to a cable in a perspective view.

FIG. 1B illustrates an example system including a tube tag assembly for attaching to a cable in a perspective view with a cut-out portion.

FIG. 2A illustrates an example system including a manufacturing procedure for creating a tube tag assembly using bent metal.

FIG. 2B illustrates an example system including a manufacturing procedure for creating a tube tag assembly using bent metal.

FIG. 3A illustrates an example system including a manufacturing procedure for creating a tube tag assembly including a skirt and a collar.

FIG. 3B illustrates an example system including a manufacturing procedure for creating a tube tag assembly including a collar with a labelling surface.

FIG. 4A illustrates an example system including a tube tag assembly with a collar having a particular mating extension configuration.

FIG. 4B illustrates an example system including a tube tag assembly with a collar having a particular mating extension configuration.

FIG. 5 illustrates an example method of manufacturing a tube tag assembly.

FIG. 6A illustrates a top perspective view of an example tube tag assembly.

FIG. 6B illustrates a front view of an example tube tag assembly.

FIG. 6C illustrates a rear view of an example tube tag assembly.

FIG. 6D illustrates a left side view of an example tube tag assembly.

FIG. 6E illustrates a right side view of an example tube tag assembly.

FIG. 6F illustrates a top view of an example tube tag assembly.

FIG. 6G illustrates a bottom view of an example tube tag assembly.

FIG. 6H illustrates a bottom perspective view of an example tube tag assembly.

FIG. 7 illustrates an example system including a tube tag assembly with a skirt formed by coupling two metal pieces together.

### DETAILED DESCRIPTION

It will be appreciated that numerous specific details are set forth in order to provide a thorough understanding of the examples described herein. However, it will be understood by those of ordinary skill in the art that the examples described herein can be practiced without these specific details. In other instances, methods, procedures and components have not been described in detail so as not to obscure the related relevant feature being described. Also, the description is not to be considered as limiting the scope of the examples described herein. The drawings are not necessarily to scale and the proportions of certain parts may be exaggerated to better illustrate details and features of the present disclosure.

Systems, methods, and devices disclosed herein include a tube tag assembly for labelling an industrial cable (e.g., a wire rope sling). The tube tag assembly can include a collar with an aperture operable to receive a cable therethrough. The collar can also include a first mating extension protruding from a first side and a second mating extension protruding from a second side. The tube tag assembly can include a skirt having a first end and a second end. The first end of the skirt can have at least one collar receiver for securing the skirt to the collar. The at least one collar receiver can include a first indentation operable to receive the first mating extension and a second indentation operable to receive the second mating extension. Additionally, the tube tag assembly can include a label surface formed onto at least one of the collar or the skirt.

In some instances, a manufacturer designing and/or fabricating tube tag assemblies for a plurality of different cable sizes can manufacture a plurality of collars having different aperture sizes to match the different cable sizes. To improve the manufacturing process, the mating extensions and/or indentations can be formed as keyed components that are distinctive to a particular aperture size. For instance, one collar having a 0.5 inch aperture diameter value can have a first mating extension with particular dimensions corresponding to a skirt with the “0.5 inch” cable size label. Another collar having a ⅝ inch aperture diameter can have a second mating extension with particular dimensions, which are different than the dimensions of the mating extension for the 0.5 inch collar, corresponding to a skirt with the “⅝ inch” cable size label. In this way, manufacturing errors can be reduced and the overall efficiency of the manufacturing process can be improved.

Additional advantages of the systems, methods, and devices disclosed herein will become apparent from the detailed description below.

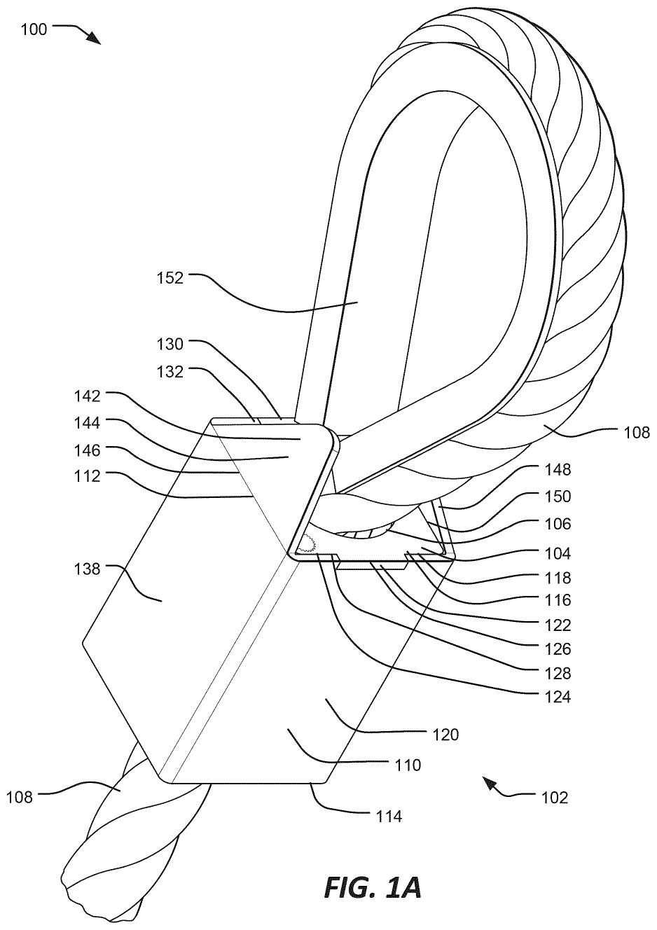

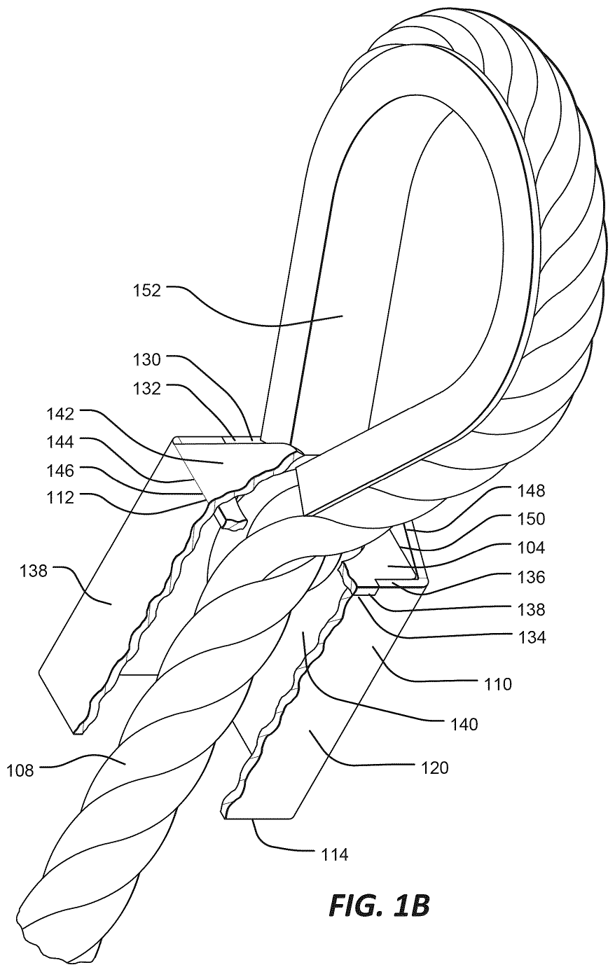

FIGS. 1A and 1B illustrate an example system 100 including a tube tag assembly 102 for attaching to and labelling industrial ropes, such as woven wire cables and/or heavy equipment rope slings. FIG. 1A shows a perspective view and FIG. 1B shows the perspective view with a partial cut-out.

In some examples, the tube tag assembly 102 can include a collar 104 with an aperture 106 operable to receive a cable 108 therethrough. For instance, the collar 102 can be formed of a flat piece of metal cut to a particular shape (e.g., a square, a rectangle, a triangle, a hexagon, or so forth). Furthermore, the tube tag assembly 102 can include a skirt 110. The skirt 110 can be defined by a first end 112 opposite a second end 114 with a collar receiver 116 formed into the first end 112. The collar receiver 116 can include an opening 118 formed at the first end 112 and/or other features shaped to receive and mate with the collar 104. For instance, the collar receiver 116 can include a substantially square-shaped opening 118 at the first end 112, formed by a plurality of sidewalls 120 of the skirt 110, matching the particular shape of the collar 102.

Furthermore, in some instances, the collar 104 can include one or more mating extensions 122 (e.g., abs, fins, protrusions, posts, etc.) formed into side edges 124 of the collar 104. The mating extensions(s) 122 can include a first mating extension 126 extending from a first side 128 of the collar 104 and a second mating extension 130 extending from a second side 132 of the collar 104 opposite from the first side 128. The collar receiver 116 of the skirt 110 can include one or more indentation(s) 134 or other receiving areas shaped to receive and mate with the mating extension(s) 122. The indentation(s) 134 can be formed into the first end 112 of the skirt 102, such as along a top edge 136. As discussed in greater detail below, the mating extension(s) 122 and/or the indentation(s) 134 can be shaped as keyed components which indicate a particular dimension of the tube tag assembly 102.

In some examples, the tube tag assembly 102 can have features operable for coupling the tube tag assembly 102 to the cable 108. For example, the aperture 106 can have a diameter dimension value and/or a circumference dimension value which corresponds to a particular diameter dimension value and/or circumference dimension value of the cable 108. Additionally, the skirt 110 can include an elongated body 138, defined between the first end 112 and the second end 114, formed by the plurality of sidewalls 120. The plurality of sidewalls 120 can include four sidewalls 120 which give the elongated body 138 of the skirt 110 a square or rectangular cross-sectional profile. Upon passing through the aperture 106, the cable 108 can also pass through an interior area 140 of the elongated body 138, exiting out both the first end 112 and the second end 114.

Additionally, the tube tag assembly 102 can include one or more cable attachment tabs 142 extending from the first end 112. For instance, a first cable attachment tab 144 can be coupled to or and/or formed into a first side edge 146 of the skirt 110, extending from the skirt 110. A second cable attachment tab 148 can be coupled to, formed into, and/or can extend from a second side edge 150 of the skirt 110, opposite the first side edge 146. Prior to being attached to the cable 108, the first cable attachment tab 144 and/or the second cable attachment tab 148 can extend in a direction parallel to the sidewalls 120 of the skirt 110. As part of an attachment procedure, the tube tag assembly 102 can be slid onto the cable 108 and the cable attachment tab(s) 142 can be bent towards each other (e.g., in a direction towards a midline of the tube tag assembly 102), pinching into a lower portion of a loop 152 of the cable 108.

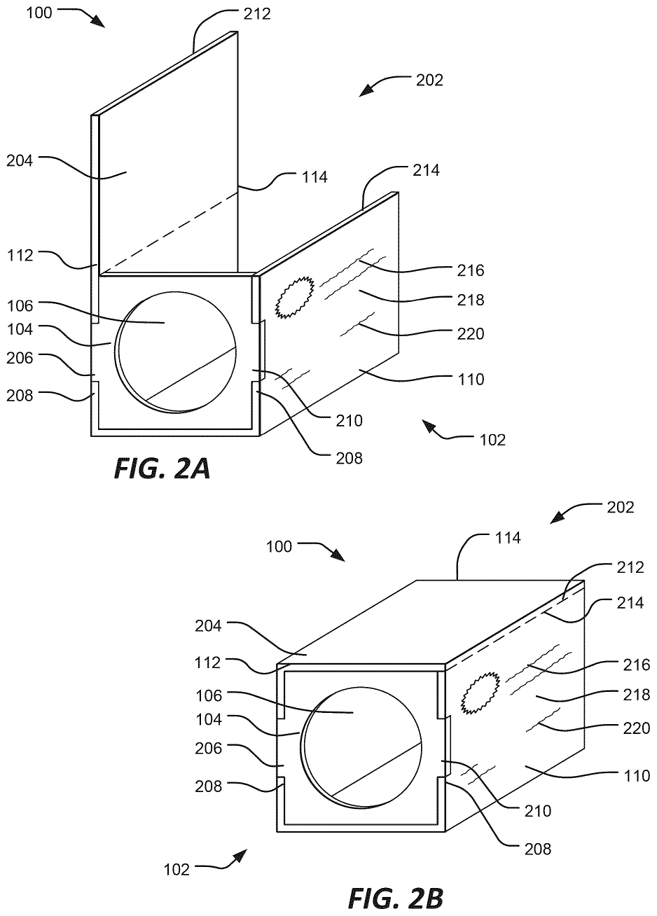

FIGS. 2A and 2B depict an example system 100 including a tube tag assembly 102 undergoing one or more operations of a manufacturing procedure 202, which can form at least a portion of the system(s) 100 depicted in FIGS. 1A and 1B.

In some examples, the tube tag assembly 102 can include a skirt 110 formed of a cut and/or bent piece of sheet metal 204. For instance, the piece of sheet metal 204 can be cut into a rectangle. A first indentation 206 can be cut into an edge 208 of the sheet metal 204 at a first location and a second indentation 210 can be cut into the edge 208 at a second location. The piece of sheet metal 204 can then be bent into a rectangular prism shape with three bends running from the first end 112 to the second end 114 along the elongated body 138. A first terminating edge 212 of the sheet metal 204 can be welded to a second terminating edge 214 once the rectangular prism shape is formed, completing the construction of the skirt 110.

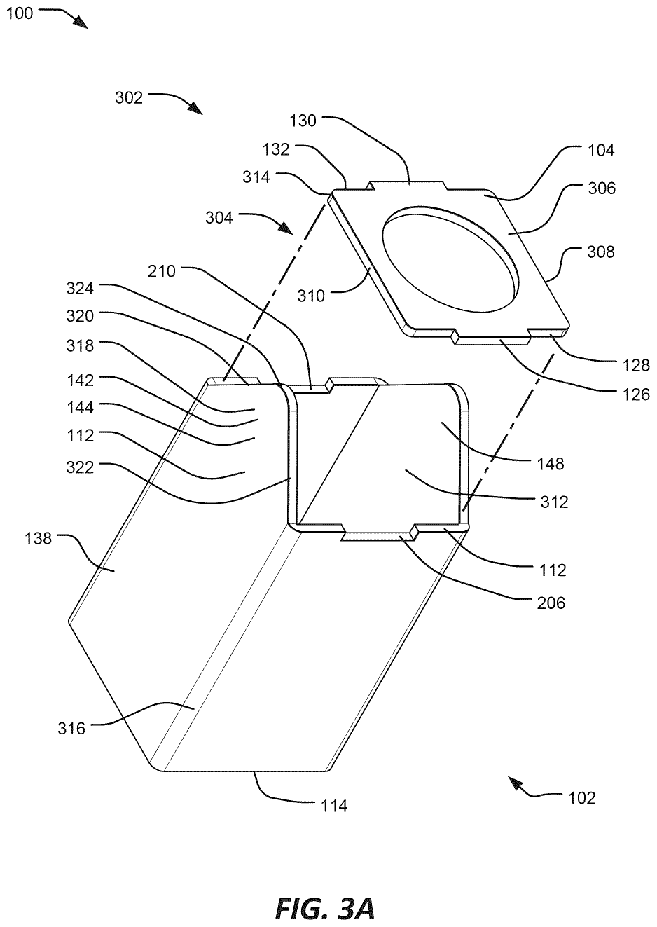

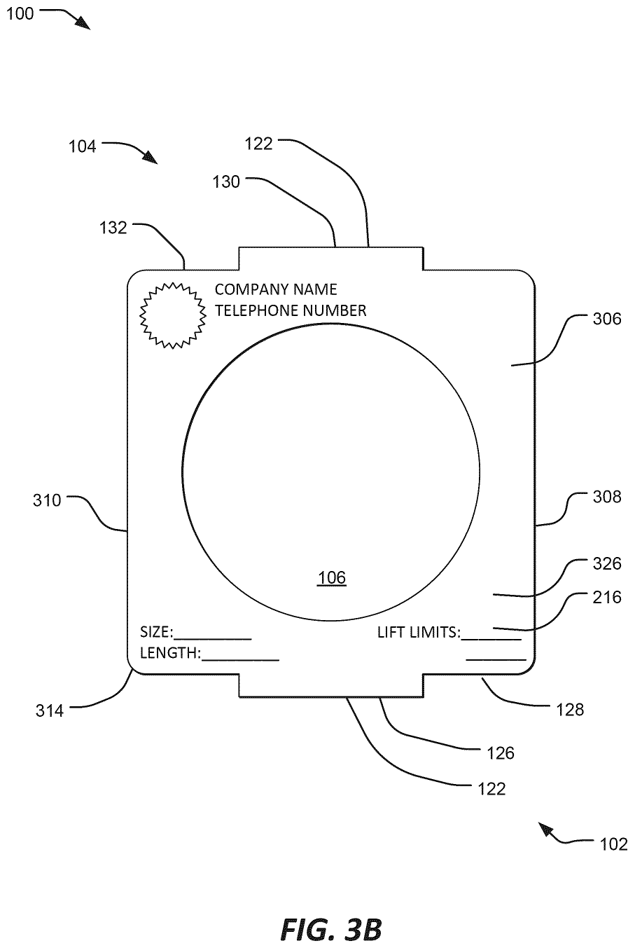

Additionally, the skirt 110 can include one or more labelling surfaces 216. For instance, an outer surface 218 of one or more sidewall(s) 120 can include space for receiving a label 220. The label 220 can be etched, printed, and/or adhered onto the labelling surface(s) 216, and can include specification information related to the cable 108 to which the tube tag assembly 102 attaches, such as a company name, a company telephone number, a cable size or diameter value, a cable length value, a cable lift limit value, and/or combinations thereof. In some instances, the collar 104 can be coupled to the skirt 110 at the collar receiver 116 (e.g., with weld, adhesives, friction-fit, and/or combinations thereof) prior to fully forming the skirt 110 into its completed shape. In other examples, (e.g., as shown in FIG. 3A), the collar 104 can be coupled to the skirt 110 at the collar receiver 116 after the skirt 110 is fully formed.

FIGS. 3A and 3B depict an example system 100 including one or more operations of a manufacturing procedure 302, including a collar attachment operation 304 which can form at least a portion of the system(s) 100 depicted in FIGS. 1A and 1B.

In some examples, as shown in FIG. 3A, the collar 104 can be inserted into the collar receiver 116 after forming the skirt 110 (e.g., via the manufacturing procedures 202 discussed above regarding FIGS. 2A and 2B). For instance, the first mating extension 126 can be aligned with the first indentation 206 and the second mating extension 130 can be aligned with the second indentation 210. The first mating extension 126 can extend from the first side 128 of the collar 104 and the second mating extension 130 can extend from the second side 132 of the collar 104. As such, the collar 104 can generally have a square shape 306 (e.g., or rectangle shape) and the first side 128 and the second side 132 can be opposite sides of the square shape 306. Furthermore, a third side 308 and a fourth side 310 of the square shape 306, disposed between the first side 128 and the second side 132, can form substantially flat edges (e.g., by omitting mating extensions 122. Additionally or alternatively, the third side 308 and/or the fourth side 310 can also include mating extensions 122. The third side 308 and/or the fourth side 310 can abut an inner surface 312 of the skirt 110, for instance, at a base of the cable attachment tabs 142, when the collar 104 is mated with the skirt 110. The square shape 306 of the collar 104 can be cut to have rounded corners 314, which correspond to and/or align with rounded corners 316 of the skirt 110 (e.g., formed by the bending operations of the skirt manufacturing procedure 202). That said, in some instances, the collar 104 can have shapes other than the square shape 306 and/or may omit the rounded corners 314 by having sharp corners instead.

Additionally, both the first cable attachment tab 144 and the second cable attachment tab 148 can extend from the elongated body 138 parallel from the elongated body 138 during this collar attachment operation 304, prior to being bent inward for attachment to the cable 108. The first cable attachment tab 144 and/or the second cable attachment tab 148 can have a generally triangular shape 318, with one side defined by the first end 112 of the skirt 110. The second side 320 and the third side 322 of the triangular shape 318 can form a peak 324, which can be a rounded peak 324, at a terminating end of the cable attachment tab(s) 142.

Furthermore, as shown in FIG. 3B, the collar 104 can include a labelling surface 216, such as a front surface 326. The front surface 326 can include the specification information related to the cable 108 to which the tube tag assembly 102 attaches, such as the company name, the company telephone number, the cable size or diameter value, the cable length value, the cable lift limit value, and/or combinations thereof.

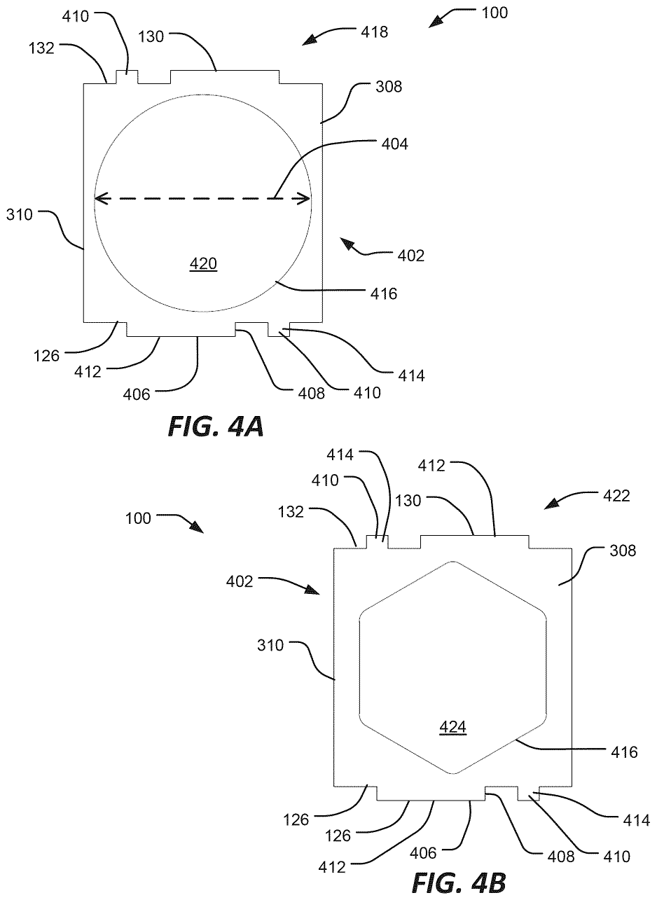

FIGS. 4A and 4B depict example systems 100 including the tube tag assembly 102 with different collar configurations 402, which can form at least a portion of the system(s) 100 depicted in FIGS. 1A and 1B.

In some examples, the different collar configurations 402 can be used to improve the manufacturing procedure(s) 202 and/or 302. Some scenarios can include manufacturing a plurality of tube tag assemblies 102 having different aperture diameter values 404 corresponding to different cable diameter values. For instance, one tube tag assembly 102 can have an aperture diameter value 404 of ⅜ inches, such that the tube tag assembly 102 is designed to attach to a cable 108 also having a ⅜ inch cable diameter value. Another tube tag assembly 102 can have a different aperture diameter value 404, for instance, 0.5 inches, which can correspond to another cable 108 having a cable diameter value of 0.5 inches.

During the manufacturing procedure(s) 202 and/or 302, challenges can arise when manufacturing a plurality of tube tag assemblies 102 having different aperture diameter values 404. For example, some metal cutters may have different tolerances than other metal cutters resulting in slight variations. Also, the collars 104 with the different sized aperture values 404 may be similar in appearance to the naked eye. Accordingly, the manufacturing procedure 202 can be improved by using the mating extensions 122 as keyed components. This means a particular collar 104 may have a particular aperture diameter value 404 (e.g., ⅜ inch, 7/16 inch, 0.5 inch, 9/16 inch, ⅝ inch, 11/16 inch, 0.75 inch, 13/16 inch, ⅞ inch, 15/16 inch, 1 inch, 1 and 1/16 inches, 1 and ⅛ inches, 1 and 3/16 inches, 1.25 inches, 1 and 5/16 inches, 1 and ⅜ inches, 1 and 5/16 inches, 1.5 inches, and so forth), and the collar 104 can have distinct mating extensions 122 that are shaped to only mate with a skirt 110 labelled with the particular aperture diameter value 404. The mating extensions 122 may have a particular width value 406 and/or a particular depth value 408 that matches the dimensions of the indentions for the skirt 110 with the matching label 220. As such, if the collar 104 for a particular aperture diameter value 404 is attempted to couple to the wrong skirt (e.g., a 0.5 inch collar 104 for a ⅝ inch skirt), the mating extensions 122 would not fit and would prevent the incorrect coupling from occurring.

In some cases, the mating extensions 122 can include a plurality of protrusions 410 extending from a same side, such as a first protrusion 412 having a first width, and a second protrusion 414 having a second width, which can be the same or different form the first width. Each collar 104 for each different cable thickness can have a unique mating extension configuration, such that the mating extensions 122 can operate as keyed components ensuring that the collar is coupled to the correct skirt 110 during the manufacturing procedure(s) 202 and/or 302. As such, part of the manufacturing procedure(s) 202 and/or 302 can include selecting the aperture diameter value 404 from a group including a plurality of different values (e.g., at least a first value, a second value, and a third value), and the one more mating extensions 122 can have a dimension indicating which of the first value, the second value, or the third value is selected for the diameter of the aperture 106.

Furthermore, the plurality of collars 104 can have different aperture shapes 416. One collar 418 can have a circular aperture shape 420 corresponding to cables 108 with a circular cross-section. Another collar 422 can have a hexagonal aperture shape 424 corresponding to cables 108 with a hexagonal cross-section. The collars 104 can have any shape to match the cable cross-sections (e.g., formed by crimping the cables 108). The collar 104 and/or the skirt 110 can be cut from sheet metal using a laser cutter during the manufacturing procedure(s) 202 and/or 302. Also, it is to be understood that any of the disclosed aspects of the mating extensions 122 and the indentations 134 (e.g., the first indentation 206 and/or the second indentation 210) can be inverted, such that the mating extensions 122 can extend from the first end 112 of the skirt 110, and the indentations 134 can be formed into the collar 104.

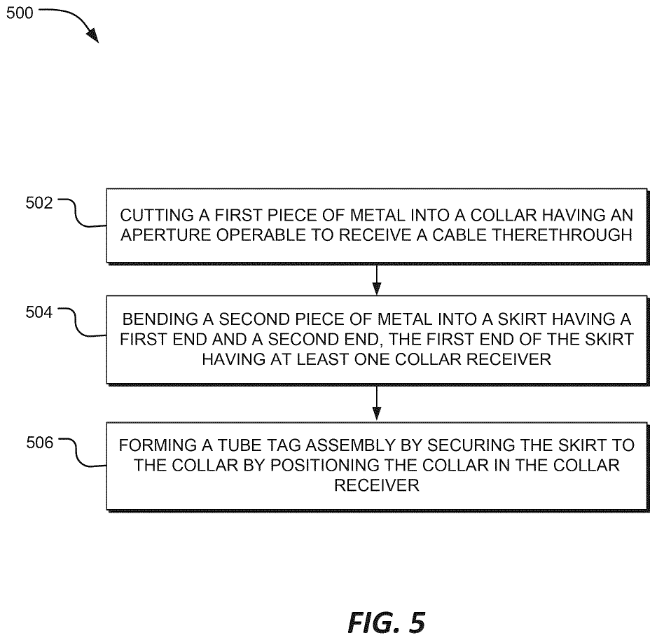

FIG. 5 depicts an example method 500 of manufacturing a tube tag assembly 102, which can be performed by any of the system(s) 100 disclosed herein.

In some instances, at operation 502, the method 500 can cut a first piece of metal into a collar having an aperture operable to receive a cable therethrough. At operation 504, the method 500 can bend a second piece of metal into a skirt having a first end and a second end, the first end of the skirt having at least one collar receiver. At operation 506, the method 500 can form a tube tag assembly by securing the skirt to the collar by positioning the collar in the collar receiver.

It is to be understood that the specific order or hierarchy of steps in the methods depicted throughout this disclosure are instances of example approaches and can be rearranged while remaining within the disclosed subject matter. For instance, any of the operations discussed throughout this disclosure may be omitted, repeated, performed in parallel, performed in a different order, and/or combined with any other of the operations discussed throughout this disclosure.

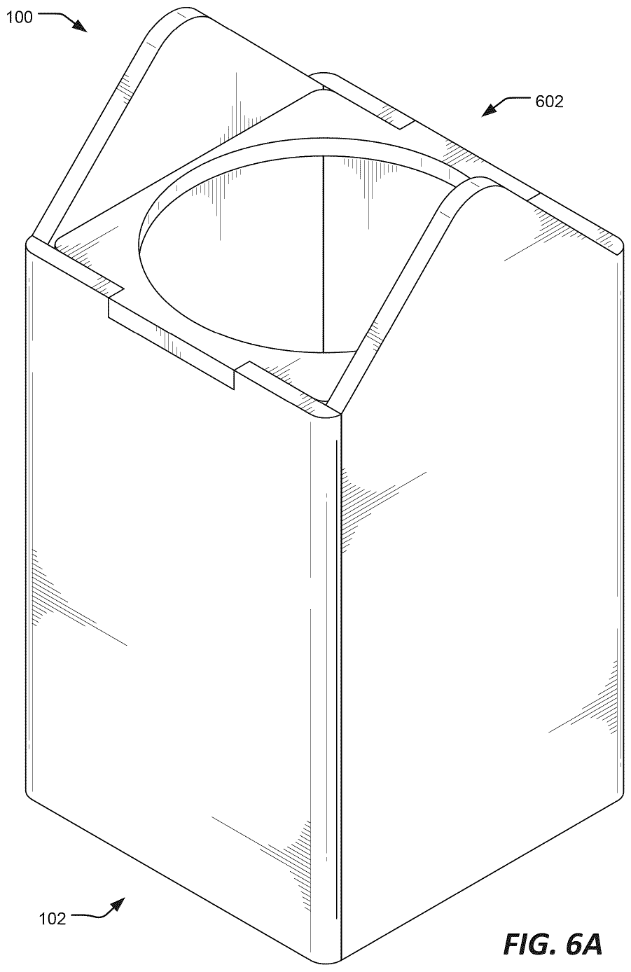

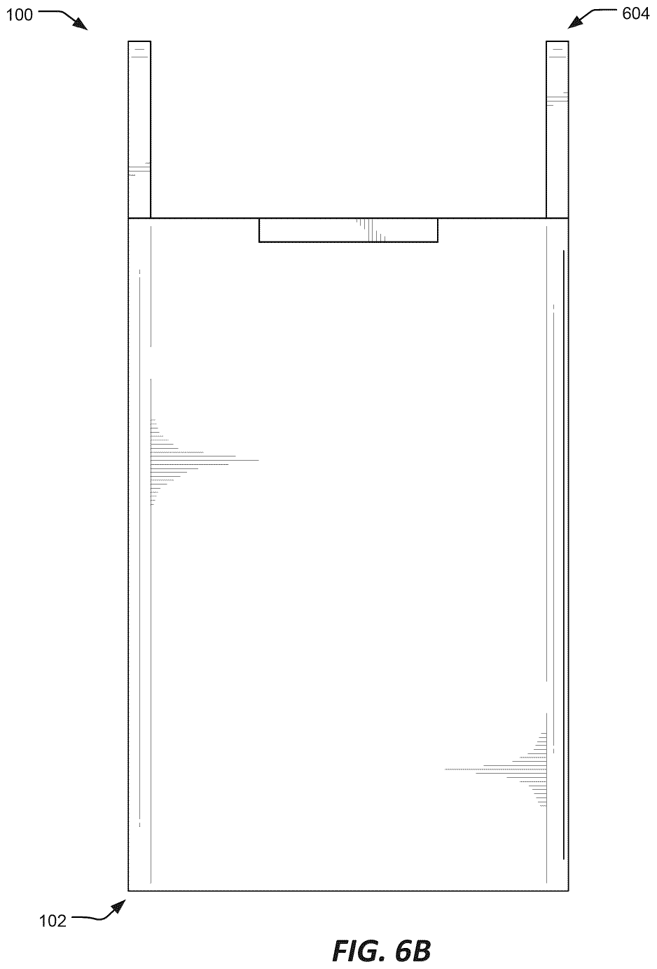

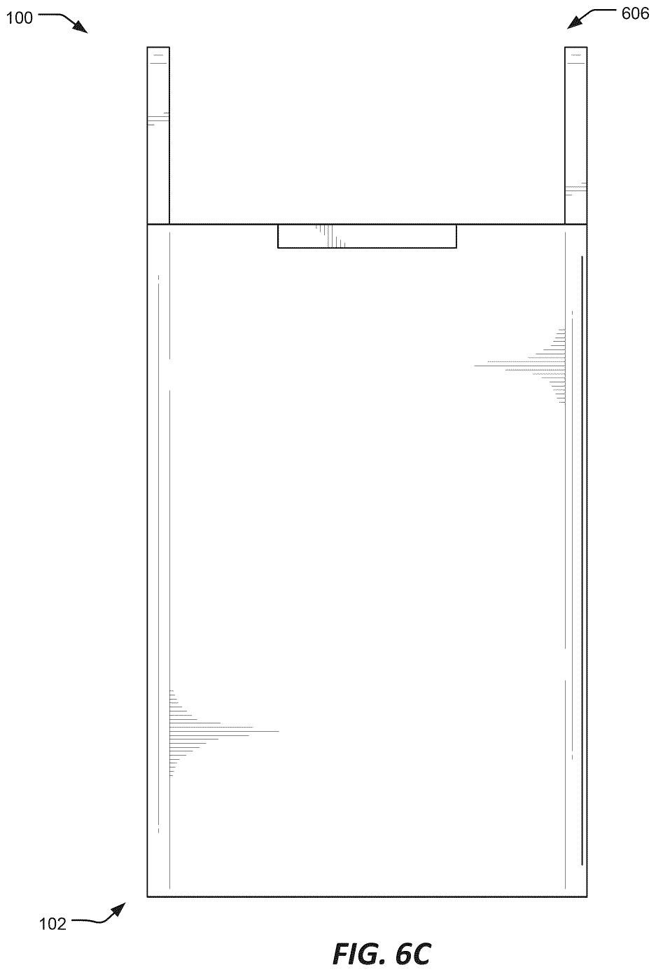

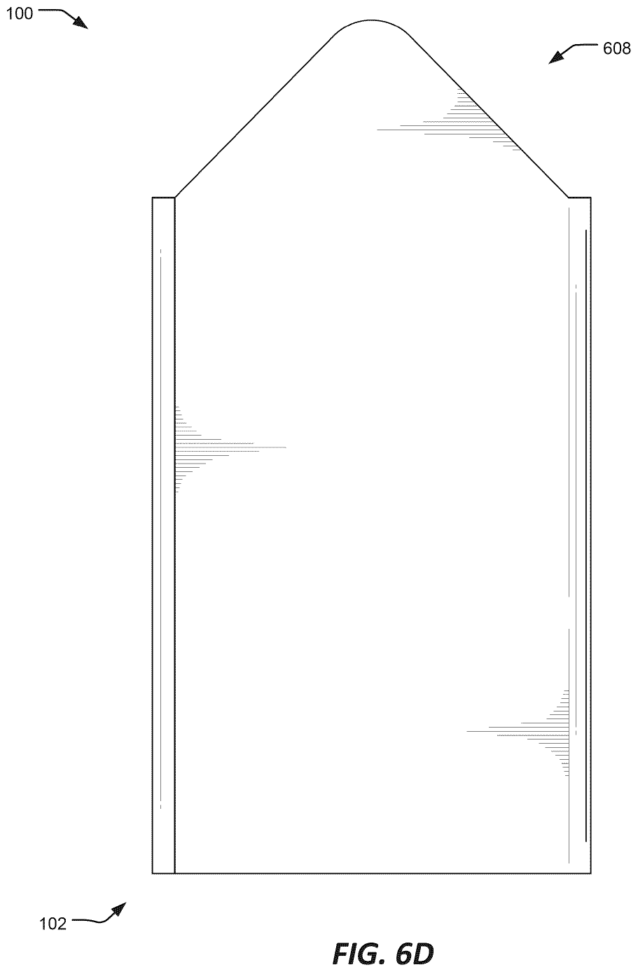

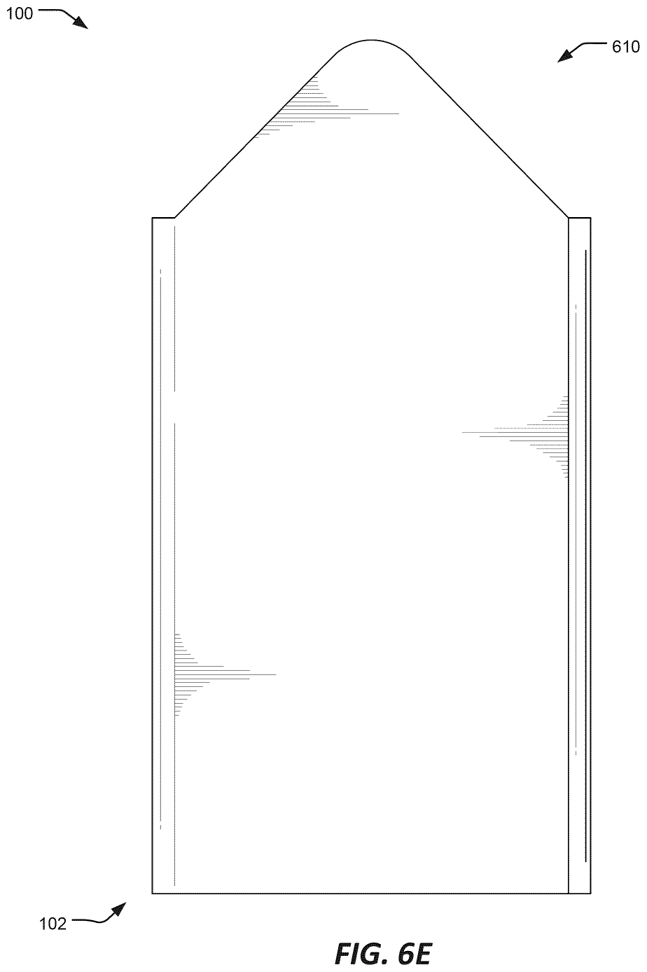

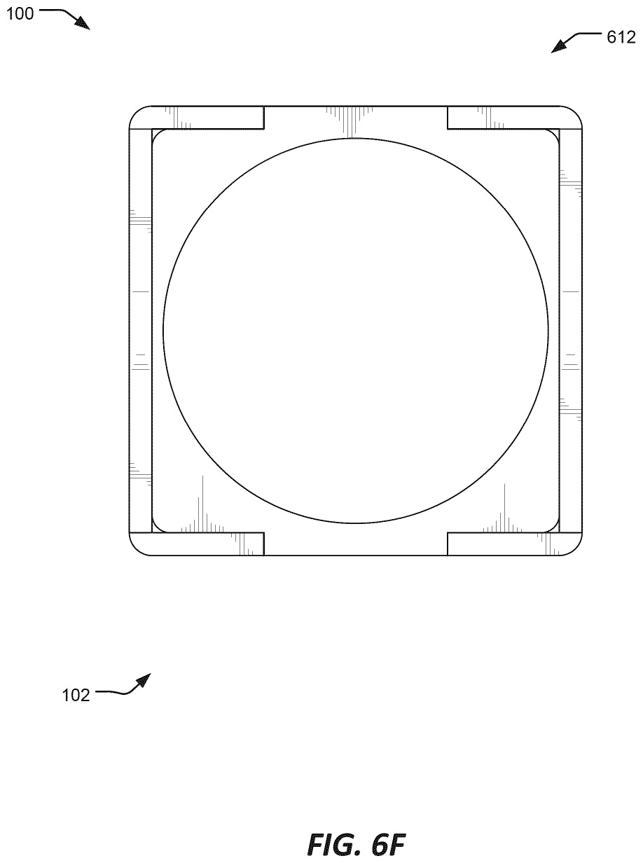

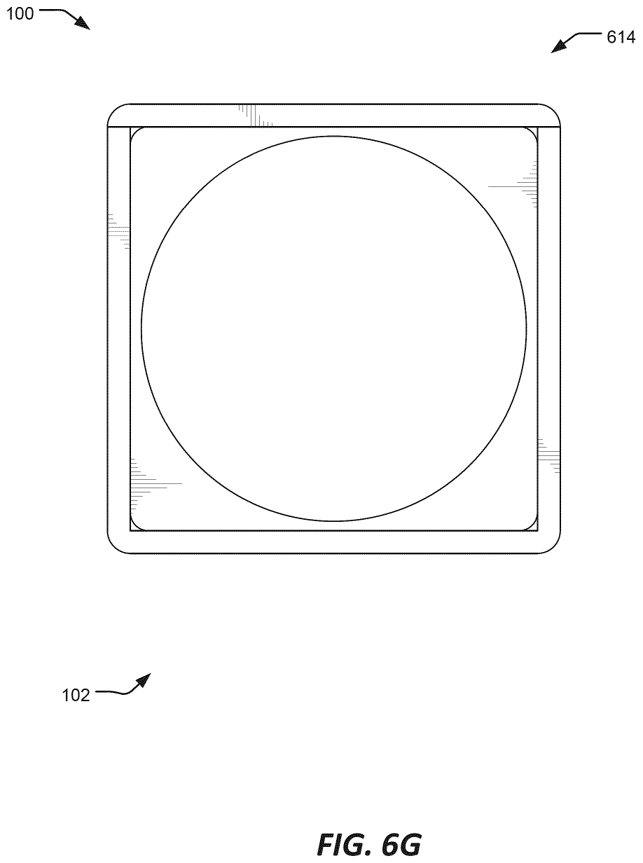

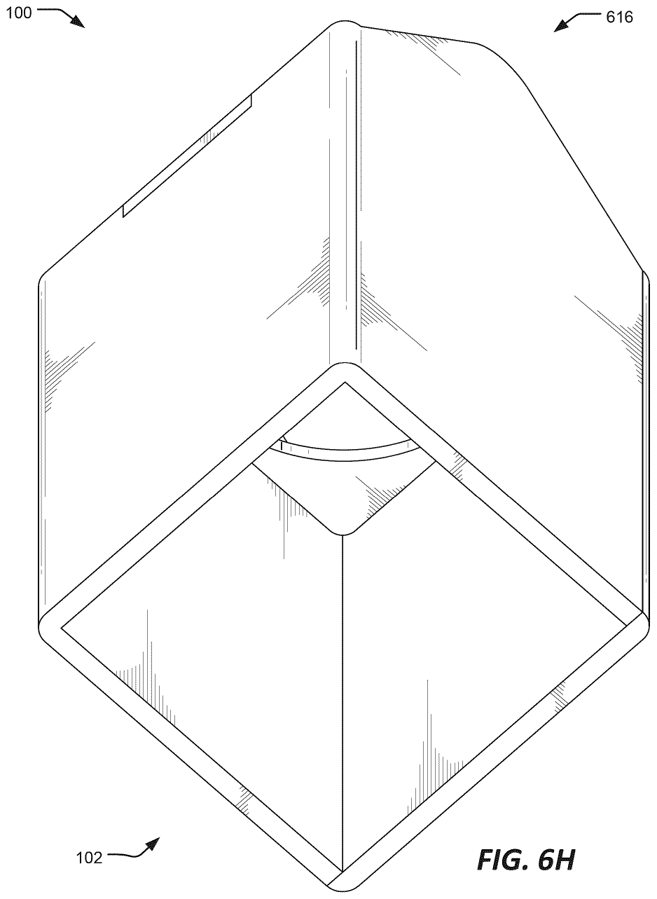

FIGS. 6A-6H depict an example system 100 including a particular example tube tag assembly 102, which can form at least a portion of the system 100 depicted in FIG. 1. As shown in FIGS. 6A-6H, the shapes and contours of the tube tag assembly 102 can create a particular visual impression and/or can include various ornamental features.

FIG. 6A depicts a top perspective view 602 of a particular example of the tube tag assembly 102.

FIG. 6B depicts a front view 604 of the particular example of the tube tag assembly 102.

FIG. 6C depicts a rear view 606 of the particular example of the tube tag assembly 102. FIG. 6D depicts a left side view 608 of the particular example of the tube tag assembly 102.

FIG. 6E depicts a right side view 610 of the particular example of the tube tag assembly 102.

FIG. 6F depicts a top view 612 of the particular example of the tube tag assembly 102.

FIG. 6G depicts a bottom view 614 of the particular example of the tube tag assembly 102.

FIG. 6H depicts a bottom perspective 616 of the particular example of the tube tag assembly 102.

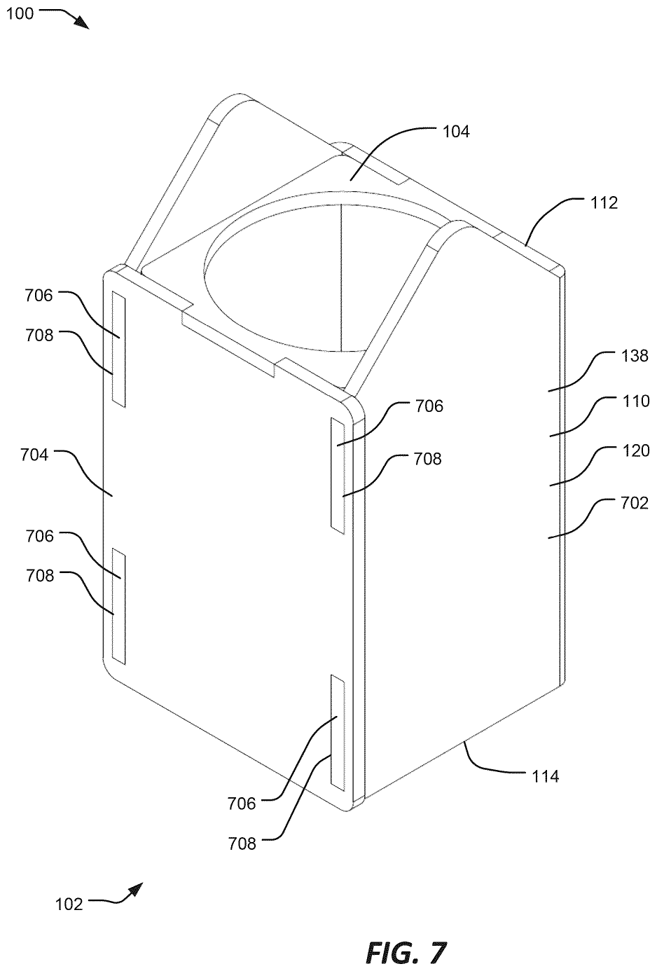

FIG. 7 depicts an example system 100 including a tube tag assembly 102, which can form at least a portion of the system 100 depicted in FIGS. 1A and 1B.

In some examples, the skirt 110 can be formed from a plurality of components. For instance, a first piece of metal 702 can be cut and bent to form some of the sidewalls 120, such as three sidewalls 120. A second piece of metal 704 can be cut and mated with the first piece of metal 704, for instance, by inserting four tabs 706 extending from sidewall edges of the first piece of metal 702 into four notches 708 in the second piece of metal. These manufacturing techniques can be used alternatively to and/or in addition to the techniques discussed above.

While the present disclosure has been described with reference to various implementations, it will be understood that these implementations are illustrative and that the scope of the present disclosure is not limited to them. Many variations, modifications, additions, and improvements are possible. More generally, implementations in accordance with the present disclosure have been described in the context of particular implementations. Functionality may be separated or combined differently in various implementations of the disclosure or described with different terminology. For example, any component disclosed herein can be combined with any other component disclosed herein. These and other variations, modifications, additions, and improvements may fall within the scope of the disclosure as defined in the claims that follow.

What is claimed is:

1. A tube tag assembly comprising:
a collar with an aperture operable to receive a cable therethrough;
a skirt having a first end and a second end, the first end of the skirt having at least one collar receiver for securing the skirt to the collar and forming the tube tag assembly; and
a label surface formed onto at least one of the collar or the skirt.

2. The tube tag assembly of claim 1,
wherein,
the collar includes one or more mating extensions, and
the collar receiver includes one or more indentations shaped to receive the one or more mating extensions.

3. The tube tag assembly of claim 2,
wherein,
the one or more mating extensions include a first mating extension protruding from a first side of the collar and a second mating extension protruding from a second side of the collar opposite the first side.

4. The tube tag assembly of claim 3,
wherein,
the collar receiver includes:
a first indentation at a first side of the skirt operable to receive the first mating extension, and
a second indentation at a second side of the skirt operable to receive the second mating extension.

5. The tube tag assembly of claim 4,
wherein,
the skirt includes a first cable attachment tab extending from the first end and a second cable attachment tab extending from the first end.

6. The tube tag assembly of claim 5,
wherein,
the first cable attachment tab extends from a third side of the skirt between the first side and the second side, and
the second cable attachment tab extends from a fourth side of the skirt between the first side and the second side.

7. The tube tag assembly of claim 6,
wherein,
the first side, the second side, the third side, and the fourth side form a square profile or a rectangle profile of the skirt.

8. The tube tag assembly of claim 4,
wherein,
the first indentation, the first mating extension, the second indentation, or the second mating extension are keyed features indicating a particular dimension of the tube tag assembly.

9. The tube tag assembly of claim 8,
wherein,
the particular dimension includes a diameter of the aperture operable to receive the cable therethrough.

10. The tube tag assembly of claim 9,
wherein,
the particular dimension is indicated by text on a top surface of the collar or on a sidewall of the skirt.

11. The tube tag assembly of claim 1,
wherein,
the skirt is formed of a bent metal sheet, and
upon positioning the collar at the collar receiver of the skirt, the collar is welded to the skirt.

12. A tube tag assembly comprising:
a collar with an aperture operable to receive a cable therethrough, the collar including one or more mating extensions;
a skirt having a first end and a second end, the first end of the skirt having at least one collar receiver to receive the one or more mating extensions of the collar; and
a label surface formed onto at least one of the collar or the skirt.

13. The tube tag assembly of claim 12,
wherein,
the aperture has a diameter selected from a group including at least a first value, a second value, and a third value, and
the one or more mating extensions have a dimension indicating which of the first value, the second value, or the third value is selected for the diameter of the aperture.

14. The tube tag assembly of claim 12,
wherein,
the collar has a first profile shape formed by an outer perimeter, and
the skirt has a second profile shape formed by a plurality of sidewalls, the second profile shape matches the first profile shape.

15. The tube tag assembly of claim 14,
wherein,
the first profile shape and the second profile shape are a square, a rectangle, a triangle, or a hexagon.

16. The tube tag assembly of claim 14,
wherein,
the aperture has a circular shape corresponding to a cable having a circular cross-section.

17. The tube tag assembly of claim 16,
wherein,
the aperture has a hexagonal shape corresponding to a cable having a hexagonal cross-section.

18. A method of manufacturing a tube tag assembly, the method comprising:
cutting a first piece of metal into a collar having an aperture operable to receive a cable therethrough;
bending a second piece of metal into a skirt having a first end and a second end, the first end of the skirt having at least one collar receiver; and
forming a tube tag assembly by securing the skirt to the collar by positioning the collar in the collar receiver.

19. The method of claim 18,
wherein,
the cutting of the first piece of metal into the collar includes forming a first mating extension into a first side of the collar and forming a second mating extension into a second side of the collar.

20. The method of claim 19,
wherein,
the securing of the skirt to the collar includes:
positioning the first mating extension into a first indentation on the skirt having a particular shape for receiving the first mating extension, and
positioning the second mating extension into a second indentation on the skirt having a particular shape for receiving the second mating extension.
